(19) United States
(12) Patent Application Publication
(10) Pub. No.: US 2020/0276957 A1
(43) Pub. Date: Sep. 3, 2020

(54) SEATBELT USE DETERMINATION DEVICE

(71) Applicant: KABUSHIKI KAISHA TOKAI-RIKA-DENKI-SEISAKUSHO, Aichi (JP)

(72) Inventors: Yuya NAGATA, Aichi (JP); Tomonari UMAKOSHI, Aichi (JP); Takuhiro SAITO, Aichi (JP); Takahiro OSAKI, Aichi (JP)

(21) Appl. No.: 16/303,364

(22) PCT Filed: May 17, 2017
(86) PCT No.: PCT/JP2017/018577

§ 371 Date: Nov. 20, 2018

(30) Foreign Application Priority Data
May 24, 2016 (JP) 2016-103544

(51) Int. Cl. B60R 22/48

(52) U.S. Cl. CPC B60R 22/48; B60R 2022/4866; B60R 2022/4808

(57) ABSTRACT

A seatbelt use determination device includes: a sensor section configured to detect insertion of a seatbelt tongue into a seatbelt buckle; a detection section configured to detect rotation of a take-up section for taking up a webbing; and a notification section that is configured to, when insertion of the tongue into the buckle has been detected by the sensor section, use a detection result of the detection section to determine a predetermined improper use of the webbing and to provide notification of the improper use. When insertion of the tongue into the buckle has been detected by the sensor section, the notification section is configured to determine improper use and to notify of the improper use in cases in which a time period during which a rotation change amount per unit time of the take-up section is continuously less than a predetermined value is longer than a predetermined first threshold.

### TECHNICAL FIELD

The present invention relates to a seatbelt use determination device that determines use of a seatbelt device configured to restrain an occupant sitting in a vehicle seat with a webbing.

### BACKGROUND ART

Seatbelt devices restrain an occupant when webbing has been put on by engaging a tongue, through which the webbing is passed, with a buckle fixed to a vehicle body. Generally, a buckle switch provided to the buckle is used to issue an alert regarding use of the seatbelt device. The alert regarding use of the seatbelt device is performed by detecting insertion of the tongue into the buckle.

However, in cases in which the seatbelt device is used improperly, for example by deliberately placing the webbing behind the body of the occupant or around the rear of a seatback and inserting the tongue into the buckle, insertion of the tongue into the buckle is detected, and so an alert regarding use of the seatbelt device is not issued.

Japanese Patent Application Laid-Open (JP-A) No. 2012-183942 proposes technology to detect when a seatbelt is being used improperly.

Specifically, the technology disclosed in JP-A No. 2012-183942 includes a door opening and closing detection device, a seatbelt use detection device, an engine start detection device to detect an operation to start an engine, an engine stop detection device to detect an operation to stop the engine, a control device to determine whether or not the seatbelt is in an improper use state, and an alert device to alert an occupant that the seatbelt is in the improper use state. An alert is issued in cases in which the seatbelt has been detected to be in an in-use state when an operation to stop the engine has been detected and when a door is detected to have transitioned from a closed state to an open state, and an operation to start the engine is then performed.

### SUMMARY OF INVENTION

### Technical Problem

However, in JP-A No. 2012-183942, after an alert has been issued, the alert can be disabled while the seatbelt device remains in an improper use state by removing and then reinserting the tongue. Therefore, there is room for improvement.

In consideration of the above circumstances, an object of the present invention is to provide a seatbelt use determination device capable of reliably detecting improper use of a seatbelt device.

### Solution to Problem

In order to achieve the above object, a seatbelt use determination device of a first aspect of the present disclosure includes a sensor section, a detection section, and a notification section. The sensor section is configured to detect insertion of a seatbelt tongue into a seatbelt buckle. The detection section is configured to detect rotation of a take-up section for taking up a webbing. When insertion of the tongue into the buckle has been detected by the sensor section, the notification section is configured to use a detection result of the detection section to determine a predetermined improper use of the webbing and to provide notification of the improper use.

In the first aspect of the present disclosure, the sensor section is configured to detect insertion of the tongue into the buckle, and the detection section is configured to detect rotation of the take-up section for taking up the webbing.

When insertion of the tongue into the buckle has been detected by the sensor section, the notification section is configured to use a detection result of the detection section to determine the predetermined improper use of the webbing and to notify of the improper use. Namely, when the webbing is used improperly, for example by being passed behind the body of the occupant or to the rear of a seatback, there is less variation in the rotation of the take-up section than when the webbing is being used correctly, enabling the notification section to employ the detection results for the rotation of the take-up section in the determination and notification of improper use. Moreover, reliable detection and notification of improper use is possible due to detecting the rotation of the take-up section even if the tongue is removed and then reinserted. Accordingly, a seatbelt use determination device capable of reliably detecting improper use of a seatbelt device is capable of being provided.

In a second aspect of the present disclosure, configuration may be made wherein when insertion of the tongue into the buckle has been detected by the sensor section, the notification section is configured to determine the improper use and to provide notification of the improper use in cases in which a time period, during which a rotation change amount per unit time of the take-up section is continuously less than a predetermined value, is longer than a predetermined first threshold. Namely, when insertion of the tongue into the buckle is detected in a case in which the webbing is being used correctly, some degree of variation in the rotation of the take-up section arises due to acceleration during travel and movement of the occupant. When the webbing is being used improperly, there is less such variation in the rotation than when the webbing is being used correctly. Accordingly, determining whether or not the time period during which the rotation change amount per unit time is continuously below the predetermined value is less than the predetermined first threshold enables reliable detection and notification of improper use of the webbing.

In a third aspect of the present disclosure, configuration may be made wherein the notification section is configured to determine the improper use and to provide notification of the improper use, in cases in which a rotation change amount of the take-up section, during a predetermined time period prior to insertion of the tongue into the buckle being detected by the sensor section, is less than a predetermined second threshold. When the webbing is being used correctly, the webbing is pulled out to some degree before being inserted into the buckle. Therefore, some degree of variation in the rotation of the take-up section in a pull-out direction arises during the predetermined time period prior to insertion of the tongue into the buckle being detected by the sensor section. When the webbing is being used improperly, there is less such variation in the rotation than when the webbing is being used correctly. Accordingly, determining whether or not the rotation change amount during the predetermined time period prior to insertion of the tongue into the buckle being detected is less than the second threshold enables reliable detection and notification of improper use of the webbing.

In a fourth aspect of the present disclosure, configuration may be made wherein the notification section is configured to determine the improper use and to provide notification of the improper use, in cases in which a rotation change amount of the take-up section, during a predetermined time period following detection of insertion of the tongue into the buckle by the sensor section, is less than a predetermined third threshold. When the webbing is being used correctly, the webbing is pulled out to some degree before being inserted into the buckle. Therefore, some degree of variation in the rotation of the take-up section in a take-up direction arises following the predetermined time period after insertion of the tongue into the buckle has been detected by the sensor section. When the webbing is being used improperly, there is less such variation in the rotation than when the webbing is being used correctly. Accordingly, determining whether or not the rotation change amount following the predetermined time period after insertion of the tongue into the buckle has been detected is less than the third threshold enables reliable detection and notification of improper use of the webbing.

### Advantageous Effects of Invention

As described above, the present invention exhibits the advantageous effect of being able to provide a seatbelt use determination device capable of reliably detecting improper use of a seatbelt device.

### BRIEF DESCRIPTION OF DRAWINGS

FIG. 1 is a face-on view illustrating an overall seatbelt device configuring a determination target for a seatbelt use determination device according to an exemplary embodiment.

FIG. 2 is a block diagram illustrating configuration of a seatbelt use determination device according to the present exemplary embodiment.

FIG. 3 is a diagram to explain a determination method for improper use of a seatbelt device, employed by a seatbelt use determination device according to the present exemplary embodiment.

FIG. 4 is a flowchart illustrating an example of a flow of processing performed by a controller of a seatbelt use determination device according to the present exemplary embodiment.

FIG. 5 is a diagram to explain a modified example of a determination method for improper use of a seatbelt device, employed by a seatbelt use determination device according to the present exemplary embodiment.

FIG. 6 is a flowchart illustrating a first modified example of a flow of processing performed by a controller of a seatbelt device according to the present exemplary embodiment.

FIG. 7 is a flowchart illustrating a second modified example of a flow of processing performed by a controller of a seatbelt device according to the present exemplary embodiment.

FIG. 8 is a flowchart illustrating a third modified example of a flow of processing performed by a controller of a seatbelt device according to the present exemplary embodiment.

### DESCRIPTION OF EMBODIMENTS

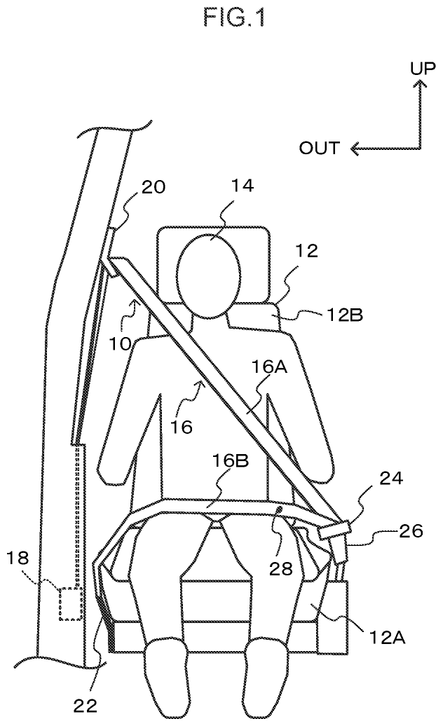

Detailed explanation follows regarding an example of an exemplary embodiment of the present invention, with reference to the drawings. FIG. 1 is a face-on view of an overall seatbelt device configuring a determination target for a seatbelt use determination device according to the present exemplary embodiment. In FIG. 1, the arrow OUT points toward a vehicle width direction outside (vehicle right side), and the arrow UP points upward.

As illustrated in FIG. 1, a seatbelt device 10 is provided to a vehicle seat 12. The front, right, and upper side of the seat 12 are respectively aligned with the front, right, and upper side of the vehicle. A lower section of the seat 12 is provided with a seat cushion 12A, and a rear section of the seat 12 is provided with a seatback 12B. A vehicle occupant 14 is able to sit on the seat 12.

The seatbelt device 10 further includes a flexible, elongated strap-shaped webbing 16 (belt).

The webbing 16 is taken up and stored by a take-up device 18, serving as a take-up section, from a length direction base end side of the webbing 16. The take-up device 18 is fixed to a vehicle body (or to the seat 12) at a lower portion at the vehicle width direction outside of the seat 12. The webbing 16 is pulled out toward the vehicle front side from the take-up device 18.

The take-up device 18 is provided with a lock mechanism, not illustrated in the drawings. In a vehicle emergency such as a collision (when the webbing 16 is pulled out sharply from the take-up device 18 or when the vehicle decelerates suddenly), the lock mechanism actuates, locking the webbing 16 against being pulled out from the take-up device 18.

A shoulder anchor 20 is fixed to the vehicle body (or the seat 12) at the vehicle rear side of an upper portion of a vehicle width direction outside section of the seat 12. An elongated, rectangular insertion hole is formed penetrating the shoulder anchor 20.

The webbing 16 is inserted through the insertion hole in the shoulder anchor 20, such that the webbing 16 folds back on itself and is supported by the insertion hole in the shoulder anchor 20.

A length direction leading end of the webbing 16 is supported by an anchor 22. The anchor 22 is fixed to the vehicle body (or to the seat 12) at the vehicle width direction outside and lower side of a rear section of the seat 12.

A tongue 24 is provided to a portion of the webbing 16 located between the shoulder anchor 20 and the anchor 22. An elongated, rectangular insertion hole is formed penetrating the tongue 24. The webbing 16 is inserted through the insertion hole such that the webbing 16 is capable of moving in its length direction through the insertion hole.

A buckle 26 is fixed to the vehicle body (or to the seat 12) at the vehicle width direction inside and lower side of the rear section of the seat 12. The tongue 24 is capable of being attached to and detached from the buckle 26. The webbing 16 is worn at the front side of the occupant 14 sitting in the seat 12 by pulling the webbing 16 out from the take-up device 18 and fitting the tongue 24 into the buckle 26.

The webbing 16 folds back on itself and is supported by the insertion hole in the tongue 24, such that a portion of the webbing 16 located between the shoulder anchor 20 and the tongue 24 (a portion on one side of the tongue 24) configures a shoulder webbing 16A (shoulder belt). The shoulder webbing 16A is worn diagonally across a shoulder and the chest of the occupant 14.

A portion of the webbing 16 located between the tongue 24 and the anchor 22 (a portion on the other side of the tongue 24) configures a lap webbing 16B (lap belt). The lap webbing 16B is worn horizontally across the lumbar region of the occupant 14.

A tongue stopper 28 is attached to the lap webbing 16B so as to project from both faces of the lap webbing 16B. The tongue stopper 28 limits movement of the tongue 24 toward the length direction leading end side of the webbing 16.

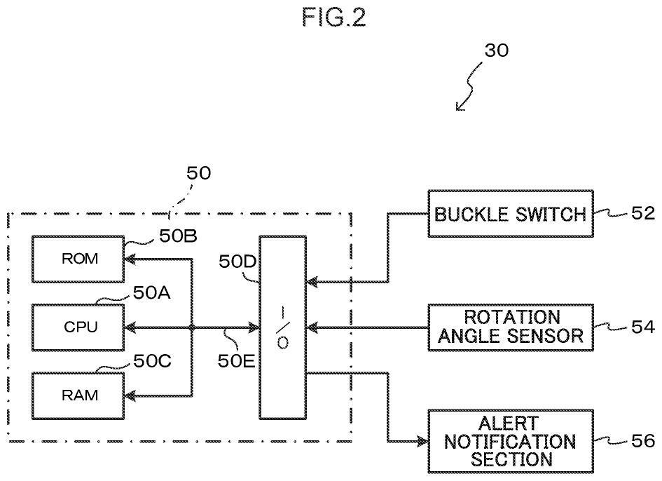

Explanation follows regarding configuration of the seatbelt use determination device according to the present exemplary embodiment. FIG. 2 is a block diagram illustrating configuration of the seatbelt use determination device according to the present exemplary embodiment.

A seatbelt use determination device 30 includes a controller 50 that serves as a notification section that detects improper use of the seatbelt device 10 and performs notification control in order to perform notification.

The controller 50 is configured by a computer in which a CPU 50A, ROM 50B, RAM 50C, and an input/output interface (I/O) 50D are connected to a bus 50E.

The ROM 50B stores a program used to perform notification control in order to detect and notify of improper use of the seatbelt device 10. The program stored in the ROM 50B is expanded into the RAM 50C and executed by the CPU 50A in order to perform the notification control to detect and notify of improper use of the seatbelt device 10.

A buckle switch 52 serving as a sensor section, a rotation angle sensor 54 serving as a detection section, and an alert notification section 56 serving as a notification section are connected to the I/O 50D.

The buckle switch 52 is a switch provided to the buckle 26, and is switched ON or OFF according to whether or not the tongue 24 is inserted into the buckle 26. A detection result of the buckle switch 52 for whether or not the tongue 24 has been inserted is input to the controller 50.

The rotation angle sensor 54 detects rotation of the take-up device 18 that takes up the webbing 16, and inputs detection results to the controller 50. The controller 50 is capable of detecting a pull-out amount or a take-up amount of the webbing 16 using the detection results of the rotation angle sensor 54. Note that in the following explanation, pull-out amounts and take-up amounts of the webbing 16 are both referred to as belt extension amount.

The alert notification section 56 uses a warning lamp, warning sound, or the like to notify the occupant when improper use of the seatbelt device 10 has been detected by the controller 50.

In the present exemplary embodiment, the seatbelt use determination device 30 detects improper use of the seatbelt device 10 based on the detection results of the rotation angle sensor 54.

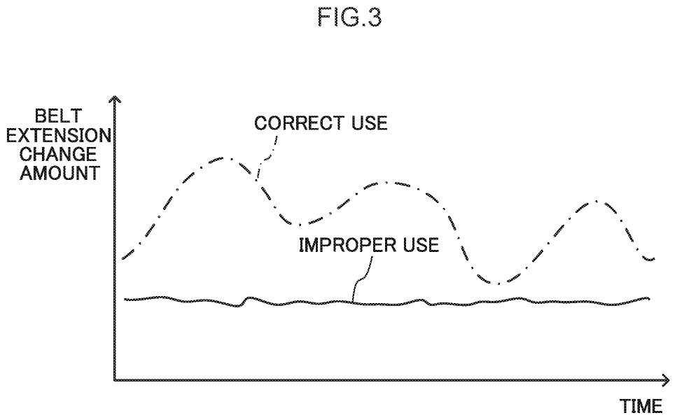

Specifically, when the seatbelt device 10 is being used correctly, as illustrated by the single-dotted dashed line in FIG. 3, the belt is pulled out or taken up to some degree in conjunction with acceleration of travel or movement of the occupant. By contrast, when the seatbelt device 10 is being used improperly, for example by passing the seatbelt device 10 behind the body of the occupant or to the rear side of the seatback 12B, as illustrated by the solid line in FIG. 3, changes in the belt extension amount (changes in the rotation amount of the take-up device 18) are much smaller than when the seatbelt device 10 is being used correctly. Accordingly, in the present exemplary embodiment, the controller 50 detects the belt extension amount when insertion of the tongue 24 into the buckle 26 has been detected, and determines and notifies that the seatbelt device 10 is being used improperly in cases in which changes in the belt extension amount are smaller than those when the seatbelt device 10 is being used correctly. More specifically, detection results of the rotation angle sensor 54 are acquired per unit time (intervals of X seconds). A time period T1 during which a belt extension change amount L is continuously less than a predetermined threshold L1 during the X-second period is detected, and in cases in which the time period T1 is longer than a predetermined threshold Ta, improper use is determined and the alert notification section 56 performs alert notification.

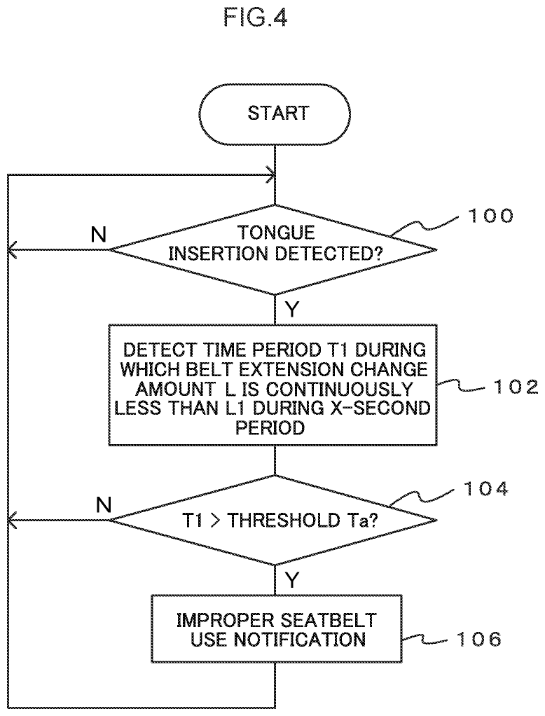

Next, explanation follows regarding specific processing performed by the controller 50 of the seatbelt use determination device 30 according to the present exemplary embodiment configured as described above. FIG. 4 is a flowchart illustrating an example of a flow of processing performed by the controller 50 of the seatbelt use determination device 30 according to the present exemplary embodiment. The processing in FIG. 4 is started when an ignition switch, not illustrated in the drawings, has been switched ON.

At step 100, the controller 50 determines whether or not tongue insertion has been detected. This determination is made by determining whether or not insertion of the tongue 24 has been detected based on a signal from the buckle switch 52. Processing stands by until determination is affirmative, and then transitions to step 102.

At step 102, the controller 50 monitors the detection results of the rotation angle sensor 54, and detects the time period T1 during which the belt extension change amount L is continuously less than L1 (L1 being a predetermined value) during the X-second period.

Processing then transitions to step 104.

At step 104, the controller 50 determines whether or not the time period T1 is longer than the predetermined threshold Ta. Namely, in a state in which insertion of the tongue 24 into the buckle 26 has been detected, the controller 50 determines the presence or absence of a state in which the rotation change amount of the take-up device 18 per unit time is continuously small as a result of improper use. Processing transitions to step 106 in cases in which determination is affirmative, and processing returns to step 100 and the above processing is repeated in cases in which determination is negative.

At step 106, the controller 50 controls the alert notification section 56 to notify of the improper use of the seatbelt device 10, and then processing returns to step 100 and the above processing is repeated.

In this manner, in the present exemplary embodiment, insertion of the tongue 24 into the buckle 26 is detected and the detection results for rotation of the take-up device 18 are employed to determine improper use of the seatbelt device 10. In cases in which the seatbelt device 10 is being used improperly, the rotation change in the take-up device 18 is smaller than when the seatbelt device 10 is being used correctly, thereby enabling improper use to be determined and notified by monitoring the rotation change. Moreover, even if the tongue 24 is removed from and then reinserted into the buckle 26 while the improper usage state continues even after improper use notification, since the change in the extension of the webbing 16 is less than it would be during correct use, improper use determination and notification can be repeated. Accordingly, insertion of the tongue 24 into the buckle 26 and rotation of the take-up device 18 are detected, and the detection results thereof are employed to determine improper use of the seatbelt device 10. This thereby enables improper use of the seatbelt device 10 to be reliably detected.

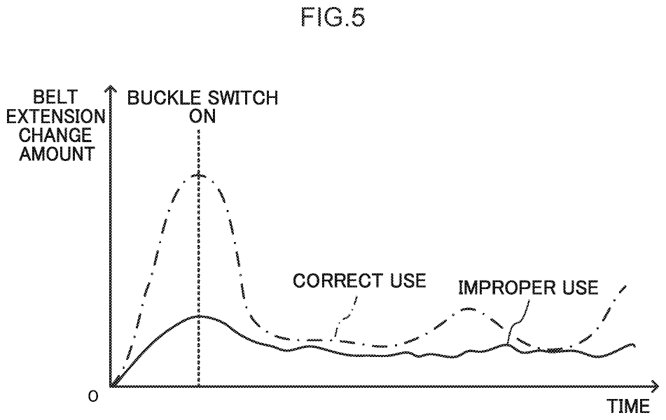

Next, explanation follows regarding a first modified example of a determination method for improper use of the seatbelt device 10 by the seatbelt use determination device 30 according to the present exemplary embodiment. FIG. 5 is a diagram to explain the modified example of the determination method for improper use of the seatbelt device by the seatbelt use determination device according to the present exemplary embodiment.

In the exemplary embodiment described above, explanation was given regarding an example in which insertion of the tongue 24 into the buckle 26 is detected and improper use is determined in cases in which the belt extension change amount is less than it would be during correct use. In the first modified example, a belt extension change amount is used to determine improper use prior to insertion of the tongue 24 into the buckle 26 being detected.

Specifically, when the seatbelt device 10 is being used correctly, the webbing 16 is pulled out by a length required in order to pass the webbing 16 to the front side of the occupant, and then the tongue 24 is inserted into the buckle 26. Accordingly, as illustrated by the single-dotted dashed line in FIG. 5, the belt extension amount changes to some degree prior to insertion of the tongue 24 into the buckle 26. However, when the seatbelt device 10 is used improperly, for example by using the seatbelt device 10 passed behind the body of the occupant or to the rear side of the seatback 12B, as illustrated by the solid line in FIG. 5, the belt extension change amount is less than when the seatbelt device 10 is used correctly. Accordingly, in the first modified example, in cases in which the belt extension change amount is less than a predetermined threshold La in a predetermined time period before the buckle switch 52 is switched ON (before insertion of the tongue 24 into the buckle 26 is detected), improper use is determined and the alert notification section 56 performs alert notification.

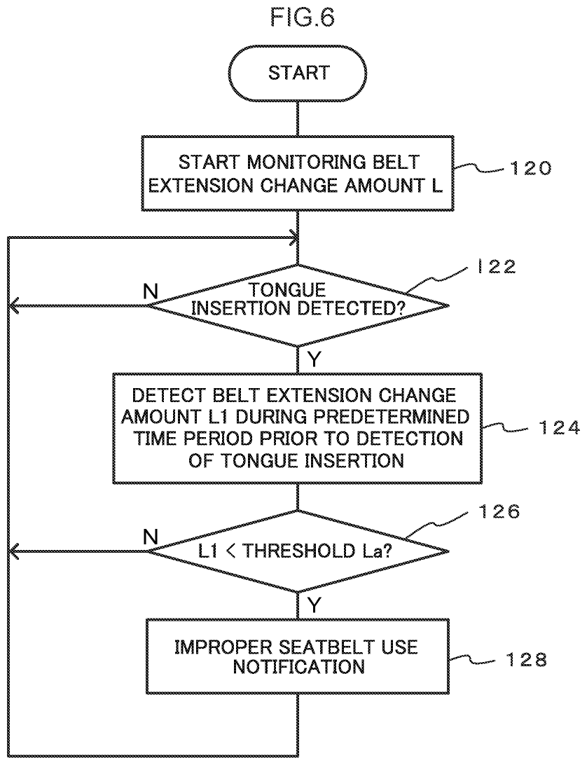

FIG. 6 is a flowchart illustrating a first modified example of a flow of processing performed by the controller of the seatbelt device according to the present exemplary embodiment. Note that the processing in FIG. 6 starts when an ignition switch, not illustrated in the drawings, has been switched ON.

At step 120, the controller 50 starts monitoring the belt extension change amount L with the rotation angle sensor 54, and processing transitions to step 122.

At step 122, the controller 50 determines whether or not tongue insertion has been detected. This determination is made by determining whether or not insertion of the tongue 24 has been detected based on a signal from the buckle switch 52. Processing stands by until determination is affirmative, and then transitions to step 124.

At step 124, based on the detection results of the rotation angle sensor 54, the controller 50 detects a belt extension change amount L1 during the predetermined time period prior to the detection of tongue insertion, and processing transitions to step 126.

At step 126, the controller 50 determines whether or not the belt extension change amount L1 is less than the predetermined threshold La. Processing returns to step 122 and the above processing is repeated in cases in which determination is negative, and processing transitions to step 128 in cases in which determination is affirmative.

At step 128, the controller 50 controls the alert notification section 56 to notify of the improper use of the seatbelt device 10, and then processing returns to step 120 and the above processing is repeated.

In this manner, in the first modified example, the belt extension change amount is detected during the predetermined time period prior to insertion of the tongue 24 into the buckle 26 being detected, and the detection results thereof are employed to determine improper use of the seatbelt device 10. In cases in which the seatbelt device 10 is being used improperly, the rotation change in the take-up device 18 in the predetermined time period prior to insertion of the tongue 24 into the buckle 26 being detected is less than when the seatbelt device 10 is being used correctly, and therefore determination that compares this rotation change against a threshold can be employed in determination and notification of improper use. Moreover, even if the tongue 24 is removed from and then reinserted into the buckle 26 while the improper usage state continues even after improper use notification, since the change in the extension of the webbing 16 is less than it would be during correct use, improper use determination and notification can be repeated. Accordingly, in the first modified example, similarly to in the exemplary embodiment described above, improper use of the seatbelt device 10 can be reliably detected.

Next, explanation follows regarding a second modified example of a determination method for improper use of the seatbelt device 10 by the seatbelt use determination device 30 according to the present exemplary embodiment.

In the first modified example, improper use is determined employing the belt extension change amount prior to insertion of the tongue 24 into the buckle 26 being detected. However, in the second modified example, a belt extension change amount following a predetermined time period after detection of insertion of the tongue 24 into the buckle 26 is employed.

Specifically, when the seatbelt device 10 is being used correctly, the webbing 16 is pulled out by a length required in order to pass the webbing 16 to the front side of the occupant with some length to spare, and then the tongue 24 is inserted into the buckle 26. Accordingly, as illustrated by the single-dotted dashed line in FIG. 5, the belt extension amount changes to some degree as a result of the excess in the webbing being taken up after inserting the tongue 24 to the buckle 26. However, when the seatbelt device 10 is used improperly, for example by using the seatbelt device 10 passed behind the body of the occupant or to the rear side of the seatback 12B, as illustrated by the solid line in FIG. 5, the belt extension change amount after insertion of the tongue 24 into the buckle 26 is smaller than when the seatbelt device 10 is being used correctly. Accordingly, in the second modified example, in cases in which the belt extension change amount is less than a predetermined threshold Lb following a predetermined time period after the buckle switch 52 is switched ON (after insertion of the tongue 24 into the buckle 26 is detected), improper use is determined and the alert notification section 56 performs alert notification. Note that the same value as the threshold La described above may be employed as the threshold Lb, or a different value may be employed.

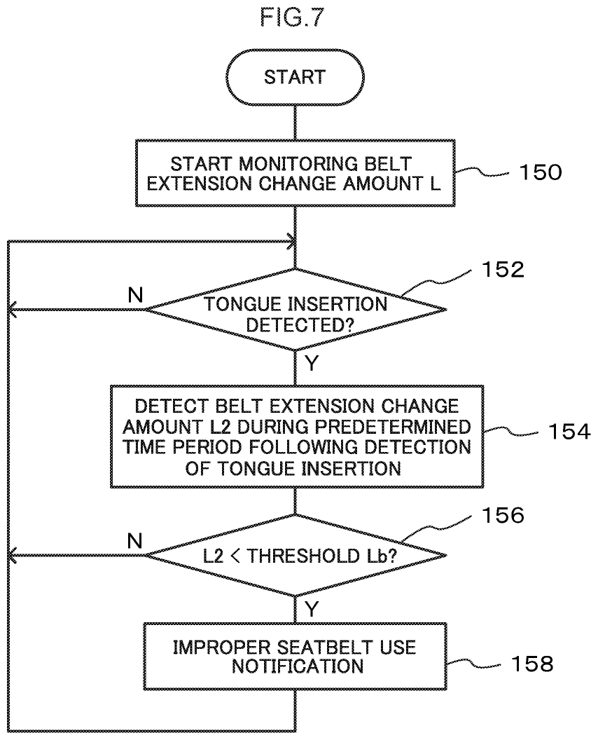

FIG. 7 is a flowchart illustrating a second modified example of a flow of processing performed by the controller of the seatbelt device according to the present exemplary embodiment. Note that the processing in FIG. 7 starts when an ignition switch, not illustrated in the drawings, has been switched ON.

At step 150, the controller 50 starts monitoring the belt extension change amount L with the rotation angle sensor 54, and processing transitions to step 152.

At step 152, the controller 50 determines whether or not tongue insertion has been detected. This determination is made by determining whether or not insertion of the tongue 24 has been detected based on a signal from the buckle switch 52. Processing stands by until determination is affirmative, and then transitions to step 154.

At step 154, based on the detection results of the rotation angle sensor 54, the controller 50 detects a belt extension change amount L2 during the predetermined time period after the detection of tongue insertion, and processing transitions to step 156.

At step 156, the controller 50 determines whether or not the belt extension change amount L2 is less than the predetermined threshold Lb. Processing returns to step 152 and the above processing is repeated in cases in which determination is negative, and processing transitions to step 158 in cases in which determination is affirmative.

At step 158, the controller 50 controls the alert notification section 56 to notify of improper use of the seatbelt device 10, and then processing returns to step 150 and the above processing is repeated.

In this manner, in the second modified example, the belt extension change amount is detected following the predetermined time period after insertion of the tongue 24 into the buckle 26 has been detected, and the detection results thereof are employed to determine improper use of the seatbelt device 10. In cases in which the seatbelt device 10 is being used improperly, variation in the rotation of the take-up device 18 following the predetermined time period after detection of insertion of the tongue 24 into the buckle 26 is less than when the seatbelt device 10 is being used correctly, and therefore determination that compares variation in the rotation against a threshold can be employed in determination and notification of improper use. Moreover, even if the tongue 24 is removed from and then reinserted into the buckle 26 while the improper usage state continues even after improper use notification, since the change in the extension of the webbing 16 is less than it would be during correct use, improper use determination and notification can be repeated. Accordingly, in the second modified example, similarly to in the exemplary embodiment described above, improper use of the seatbelt device 10 can be reliably detected.

Next, explanation follows regarding a third modified example of a determination method for improper use of the seatbelt device 10 by the seatbelt use determination device 30 according to the present exemplary embodiment.

The third modified example combines the exemplary embodiment, the first modified example, and the second modified example described above.

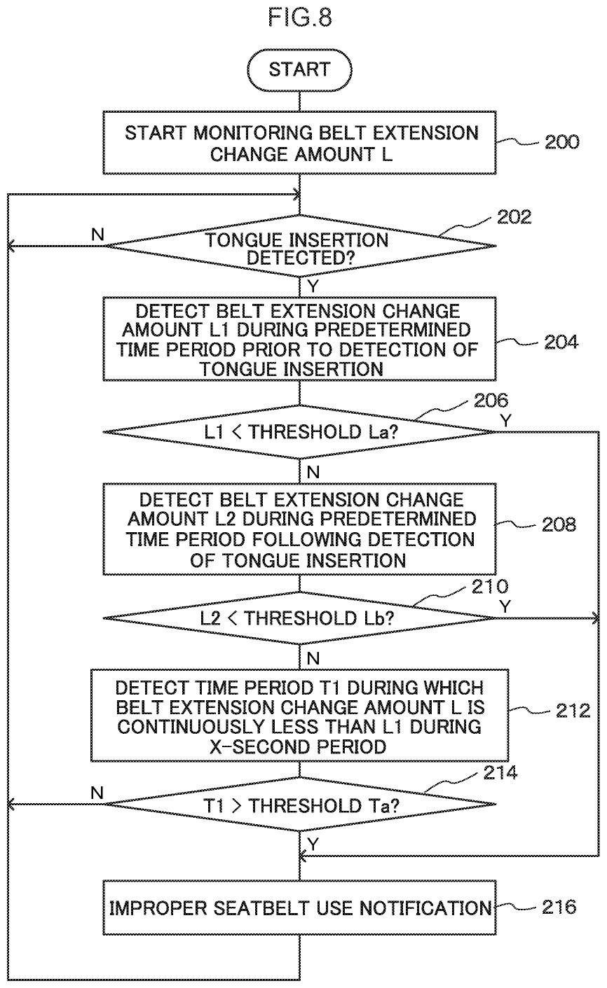

FIG. 8 is a flowchart illustrating a third modified example of the flow of processing performed by the controller of the seatbelt device according to the present exemplary embodiment. Note that the processing in FIG. 8 starts when an ignition switch, not illustrated in the drawings, has been switched ON.

At step 200, the controller 50 starts monitoring the belt extension change amount L with the rotation angle sensor 54, and processing transitions to step 202.

At step 202, the controller 50 determines whether or not tongue insertion has been detected. This determination is made by determining whether or not insertion of the tongue 24 has been detected based on a signal from the buckle switch 52. Processing stands by until determination is affirmative, and then transitions to step 204.

At step 204, based on the detection results of the rotation angle sensor 54, the controller 50 detects the belt extension change amount L1 during a predetermined time period prior to the detection of tongue insertion, and processing transitions to step 206.

At step 206, the controller 50 determines whether or not the belt extension change amount L1 is less than the predetermined threshold La. Processing transitions to step 208 in cases in which determination is negative, and processing transitions to step 216 in cases in which determination is affirmative.

At step 208, based on the detection results of the rotation angle sensor 54, the controller 50 detects a belt extension change amount L2 during the predetermined time period after the detection of tongue insertion, and processing transitions to step 210.

At step 210, the controller 50 determines whether or not the belt extension change amount L2 is less than the predetermined threshold Lb. Processing transitions to step 212 in cases in which determination is negative, and processing transitions to step 216 in cases in which determination is affirmative.

At step 212, the controller 50 monitors the detection results of the rotation angle sensor 54, and detects the time period T1 during which the belt extension change amount L is continuously less than L1 (L1 being a predetermined value) during the X-second period. Processing then transitions to step 214.

At step 214, the controller 50 determines whether or not the time period T1 is longer than the predetermined threshold Ta. Namely, the controller 50 determines the presence or absence of a state in which the belt extension change amount is small due to improper use.

Processing transitions to step 216 in cases in which determination is affirmative, and processing returns to step 202 and the above processing is repeated in cases in which determination is negative.

At step 216, the controller 50 controls the alert notification section 56 to notify of improper use of the seatbelt device 10, and then processing returns to step 202 and the above processing is repeated.

By combining the exemplary embodiment and the respective modified examples in this manner, improper use of the seatbelt device 10 can be even more reliably detected by using the extension change amounts of the webbing 16 before and after fitting the tongue 24 into the buckle 26 and while the webbing 16 is in use.

Note that in the third modified example, explanation has been given regarding an example in which the exemplary embodiment, the first modified example, and the second modified example described above are all combined. However, there is no limitation to such a combination, and any two of the above may be combined.

Moreover, explanation has been given in which the processing performed by the controller 50 in the exemplary embodiment and the modified examples described above is implemented by software. However, there is no limitation thereto. For example, the processing may be implemented by hardware, or the processing may be implemented by a combination of both hardware and software.

The processing performed by the controller 50 in the exemplary embodiment and the modified examples described above may also be stored and distributed as a program on a storage medium.

The present invention is not limited to the above description, and obviously various other modifications may be implemented within a range not departing from the spirit of the present invention.

The disclosure of Japanese Patent Application No. 2016-103544, filed on May 24, 2016, is incorporated in its entirety by reference herein.

1. A seatbelt use determination device comprising:
a sensor section configured to detect insertion of a seatbelt tongue into a seatbelt buckle;
a detection section configured to detect rotation of a take-up section for taking up a webbing; and
a notification section that is configured to, when insertion of the tongue into the buckle has been detected by the sensor section, use a detection result of the detection section to determine a predetermined improper use of the webbing and to provide notification of the improper use.

2. The seatbelt use determination device of claim 1, wherein the notification section is configured to, when insertion of the tongue into the buckle has been detected by the sensor section, determine the improper use, and to provide notification of the improper use in cases in which a time period, during which a rotation change amount per unit time of the take-up section is continuously less than a predetermined value, is longer than a predetermined first threshold.

3. The seatbelt use determination device of claim 1, wherein the notification section is configured to determine the improper use and to provide notification of the improper use, in cases in which a rotation change amount of the take-up section, during a predetermined time period prior to insertion of the tongue into the buckle being detected by the sensor section, is less than a predetermined second threshold.

4. The seatbelt use determination device of claim 1, wherein the notification section is configured to determine the improper use and to provide notification of the improper use, in cases in which a rotation change amount of the take-up section, during a predetermined time period following detection of insertion of the tongue into the buckle by the sensor section, is less than a predetermined third threshold.

5. The seatbelt use determination device of claim 1, further comprising an alert notification section configured to notify an occupant, in cases in which improper use of a seatbelt device has been determined by the notification section.

6. The seatbelt use determination device of claim 5, wherein the alert notification section notifies the occupant using light or sound.
